(19) United States
(12) Patent Application Publication
(10) Pub. No.: US 2026/0301335 A1
(43) Pub. Date: Oct. 1, 2026

(54) INFORMATION PROCESSING DEVICE, DISPLAY SYSTEM, AND NON-TRANSITORY COMPUTER READABLE MEDIUM

(71) Applicant: FUJIFILM Business Innovation Corp., Tokyo (JP)

(72) Inventors: Nanaka IKEDA, Kanagawa (JP); Hirotake SASAKI, Kanagawa (JP); Jungo HARIGAI, Kanagawa (JP); Ko TAKEUCHI, Kanagawa (JP); Masami SUDO, Kanagawa (JP); Hiroshi NIMIYA, Kanagawa (JP); Arisa YOSHIDA, Kanagawa (JP); Yukiko USAMI, Kanagawa (JP); Satoshi EGAWA, Kanagawa (JP); Masaki NISHIKAWA, Kanagawa (JP)

(73) Assignee: FUJIFILM Business Innovation Corp., Tokyo (JP)

(21) Appl. No.: 19/303,844

(22) Filed: Aug. 19, 2025

(30) Foreign Application Priority Data
Mar. 26, 2025 (JP) 2025-052353

(51) Int. Cl. G06T 19/00

(52) U.S. Cl. CPC G06T 19/006

(57) ABSTRACT

An information processing device includes a processor configured to function as a display information generation unit that generates display information of a three-dimensional XR (AR/VR/MR) space to be displayed on a display device possessed by a user, and as the display information generation unit; generate a first image obtained by converting a recognized first voice into text information; generate a second image obtained by converting a second voice recognized after the first voice into text information; and generate the display information in which the first image and the second image are arranged on different planes in the three-dimensional XR (AR/VR/MR) space.

### CROSS-REFERENCE TO RELATED APPLICATIONS

This application is based on and claims priority under 35 USC 119 from Japanese Patent Application No. 2025-052353 filed Mar. 26, 2025.

### BACKGROUND

### (i) Technical Field

The present disclosure relates to an information processing device, a display system, and a non-transitory computer readable medium.

### (ii) Related Art

Japanese Unexamined Patent Application Publication No. 2018-73237 discloses a technology for displaying a meeting display screen in which the details of a meeting are stored. On the meeting display screen, texts obtained by performing voice recognition on remarks of the participants in the meeting, materials referred to in the meeting, and the like are displayed in a balloon.

### SUMMARY

When a plurality of images obtained by converting voices into text information is arranged and displayed on the same plane in a three-dimensional XR (AR/VR/MR) space, the amount of displayable text information is limited.

Aspects of non-limiting embodiments of the present disclosure relate to increasing the amount of displayable text information compared to the case where a plurality of images obtained by converting voices into text information is arranged and displayed on the same plane in a three-dimensional XR (AR/VR/MR) space.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing device including a processor configured to function as a display information generation unit that generates display information of a three-dimensional XR (AR/VR/MR) space to be displayed on a display device possessed by a user, and as the display information generation unit: generate a first image obtained by converting a recognized first voice into text information; generate a second image obtained by converting a second voice recognized after the first voice into text information; and generate the display information in which the first image and the second image are arranged on different planes in the three-dimensional XR (AR/VR/MR) space.

### BRIEF DESCRIPTION OF THE DRAWINGS

An exemplary embodiment of the present disclosure will be described in detail based on the following figures, wherein:

FIG. 1 is a diagram illustrating an overall configuration of an information processing system of the present exemplary embodiment;

FIG. 2 is a diagram illustrating a configuration of a management server;

FIG. 3 is a diagram illustrating a hardware configuration of an individual device;

FIG. 4 is a diagram illustrating an example of the details of a conversation held between a first nearby person and a second nearby person;

FIG. 5 is a diagram illustrating an example of an arrangement of images generated by a CPU of a control device in a three-dimensional space;

FIG. 6 is a diagram illustrating an example of a screen displayed on a display device;

FIG. 7 is a diagram illustrating another example of a screen displayed on the display device;

FIG. 8 is a diagram illustrating another example of an arrangement of images generated by the CPU of the control device in a three-dimensional space; and

FIG. 9 is a diagram illustrating an example of a screen displayed on the display device.

### DETAILED DESCRIPTION

Hereinafter, an exemplary embodiment of the present disclosure will be described with reference to the attached drawings.

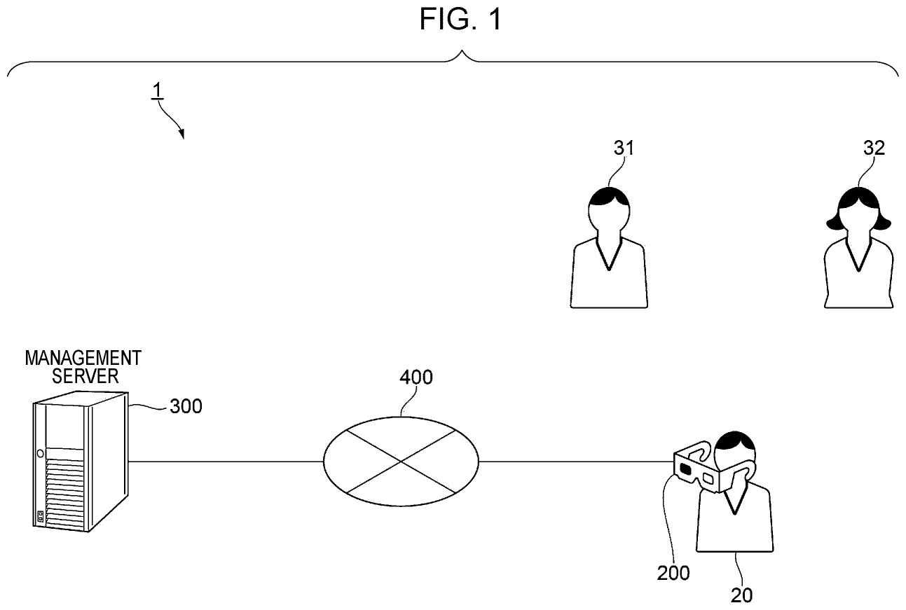

FIG. 1 is a diagram illustrating an overall configuration of an information processing system 1 of the present exemplary embodiment.

The information processing system 1 is provided with a management server 300. Further, the information processing system 1 is provided with an individual device 200 prepared for a user. The individual device 200 is a glasses-type device and is worn on the head of a user 20.

The information processing system 1 of the present exemplary embodiment implements extended reality (XR) technology for displaying a virtual image in a three-dimensional space. The XR technology includes virtual reality (VR) technology for displaying a virtual image in a virtual three-dimensional space. The XR technology also includes augmented reality (AR) technology for displaying a virtual image in a real three-dimensional space. The XR technology also includes mixed reality (MR) technology that is a combination of VR and AR. In the present exemplary embodiment, these are sometimes collectively referred to as XR (AR/VR/MR).

The individual device 200 displays an image within the field of view of the user 20. In response to this, the user 20 visually recognizes this image. The user 20 also visually recognizes his/her surroundings through the individual device 200.

The individual device 200 is connected to the management server 300 via a communication line 400. The communication line 400 may be a wired communication line or a wireless communication line.

While one individual device 200 is provided in this example, a plurality of individual devices 200 may be provided depending on the number of users when there is a plurality of users.

### Configuration of Management Server 300

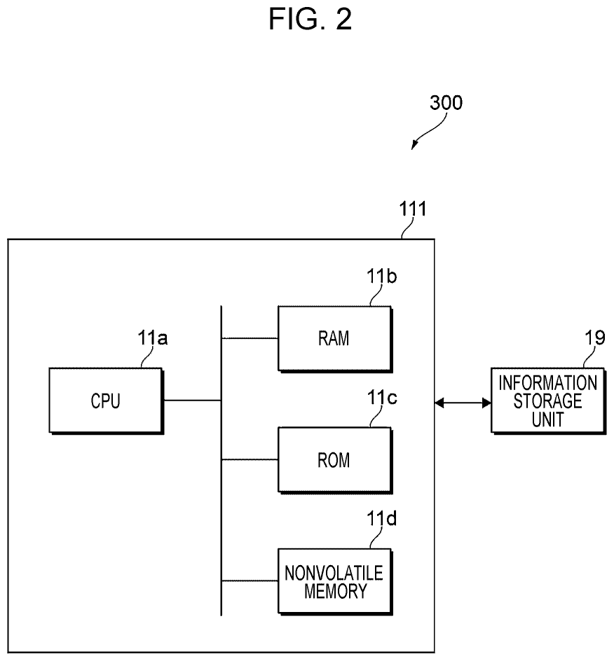

FIG. 2 is a diagram illustrating a configuration of the management server 300. The management server 300 is realized by a computer.

The management server 300 includes an arithmetic processing unit 111 that executes digital arithmetic processing in accordance with a program and an information storage unit 19 that stores information.

The information storage unit 19 is realized by an existing information storage device. For example, the information storage unit 19 is composed of a hard disk drive (HDD), a semiconductor memory, a magnetic tape, or the like.

The arithmetic processing unit 111 is provided with a CPU 11a as an example of a processor.

The arithmetic processing unit 111 is also provided with a RAM 11b used as a working memory for the CPU 11a or the like, and a ROM 11c in which a program to be executed by the CPU 11a or the like is stored.

The arithmetic processing unit 111 is also provided with a nonvolatile memory 11d that is rewritable and can retain data even when power supply is stopped.

For example, the nonvolatile memory 11d is composed of a battery-backed SRAM, a flash memory, or the like. The information storage unit 19 stores various types of information such as a program to be executed by the arithmetic processing unit 111.

In the present exemplary embodiment, the CPU 11a provided in the arithmetic processing unit 111 loads the program stored in the ROM 11c or the information storage unit 19, so that various types of processes performed in the management server 300 are executed.

The program to be executed by the CPU 11a may be provided to the management server 300 via a recording medium.

Examples of the recording medium include magnetic recording media such as a magnetic tape and a magnetic disk. Other examples of the recording medium include optical recording media such as an optical disk.

Other examples of the recording medium include a magnetooptical recording medium. Other examples of the recording medium also include a semiconductor memory and the like.

The program to be executed by the CPU 11a may be provided to the management server 300 via communication means such as the Internet.

### Configuration of Individual Device

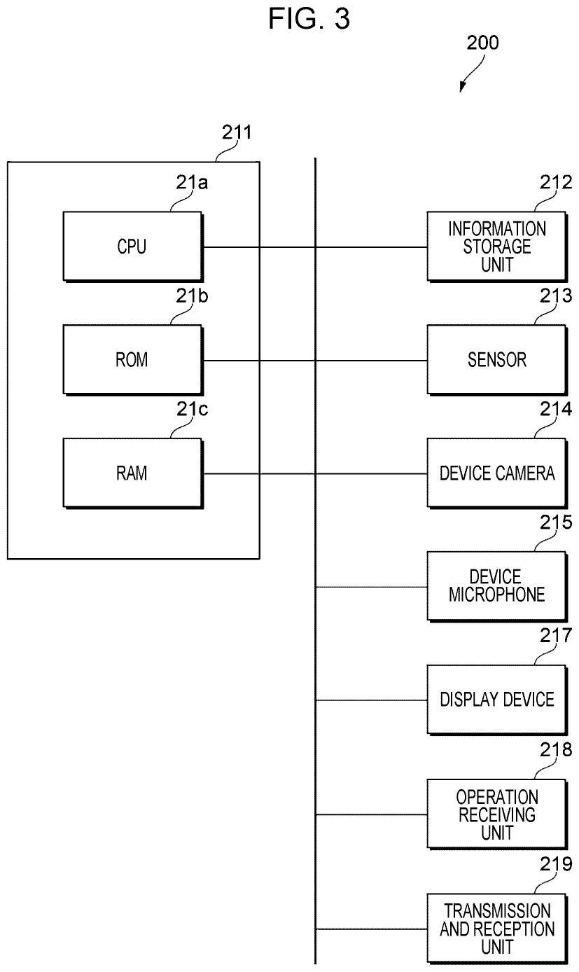

FIG. 3 is a diagram illustrating a hardware configuration of the individual device 200.

The individual device 200 includes a control device 211, an information storage unit 212, a sensor 213, a device camera 214, and a device microphone 215. The individual device 200 further includes a display device 217, an operation receiving unit 218, and a transmission and reception unit 219.

The control device 211 is provided with a CPU 21a as an example of a processor.

The control device 211 is also provided with a RAM 21c used as a working memory for the CPU 21a or the like, and a ROM 21b in which a program to be executed by the CPU 21a or the like is stored.

The information storage unit 212 is realized by an existing information storage device such as a semiconductor memory.

Examples of the sensor 213 include a GPS sensor, a direction sensor, an acceleration sensor, and a gyro sensor. Other examples of the sensor 213 include light detection and ranging (LiDAR). LiDAR performs optical detection and distance measurement.

When LiDAR is provided, the distance between the individual device 200 and a nearby object or person around the individual device 200 can be identified. When LiDAR is provided, the positional relationship between the individual device 200 and the nearby object or person can be identified.

In the present exemplary embodiment, by referring to the output from the sensor 213, the current position of the individual device 200 and the orientation of the individual device 200 can be identified. By referring to the output from the sensor 213, as described above, the distance between the individual device 200 and a nearby object can be identified, and the positional relationship between the individual device 200 and the nearby object can be identified.

The device camera 214 is a camera that captures a video of the surroundings of the individual device 200.

In a state where the individual device 200 is worn by the user 20, the device camera 214 faces the forward direction of the user 20 and captures a video in that direction. In other words, the device camera 214 faces the direction in which the user 20 faces, and captures a video in the front direction of the user 20. The device camera 214 acquires a video within the field of view of the user 20.

The device microphone 215 acquires voices around the individual device 200 and generates voice information.

The display device 217 is a so-called display and displays various types of information. In the state where the individual device 200 is worn by the user 20, the display device 217 is placed right in front of the user 20.

In the present exemplary embodiment, the display device 217 displays a video obtained by the device camera 214. In the state where the individual device 200 is worn by the user 20, the display device 217 displays a video showing the state in front of the user 20.

In the present exemplary embodiment, the user 20 visually recognizes the real space in front of the user 20 by referring to the video displayed on the display device 217.

The operation receiving unit 218 is a functional unit that receives an operation from a user. For example, the operation receiving unit 218 is composed of a switch or a touch panel.

The transmission and reception unit 219 is a functional unit that transmits and receives commands and data to and from an external device connected to the individual device 200 via a communication line. Examples of the external device include the management server 300 described above.

In addition, the individual device 200 may be a see-through-type individual device 200.

In the see-through-type individual device 200, a transparent display device 217 that allows the user 20 to visually recognize the space behind the display device 217 is installed as the display device 217.

More specifically, in this case, a transparent display panel is installed as the display device 217. Through the display panel, the user 20 can visually recognize the situation behind the display panel.

In this case, the user 20 visually recognizes the space behind the display device 217 through the display device 217. In other words, the user 20 visually recognizes the space in front of the user 20 through the display device 217.

With the see-through-type individual device 200, the user 20 visually recognizes the real space that is present behind the display device 217 and that can be seen through the display device 217 and an image displayed on the display device 217.

The program to be executed by the CPU 21a may be provided to the individual device 200 via a recording medium.

Examples of the recording medium include magnetic recording media such as a magnetic tape and a magnetic disk. Other examples of the recording medium include optical recording media such as an optical disk.

Other examples of the recording medium include a magnetooptical recording medium. Other examples of the recording medium also include a semiconductor memory and the like.

The program to be executed by the CPU 21a may be provided to the individual device 200 via communication means such as the Internet.

The individual device 200 is not limited to the glasses-type individual device 200, and may be, for example, a smartphone, a tablet terminal or the like.

All of the glasses-type individual device 200, smartphone, tablet terminal, and the like are devices that can be carried by the user 20.

Smartphones and tablet terminals are also provided with the display device 217 and the device camera 214. By referring to the video captured by the device camera 214 and displayed on the display device 217, the user 20 can visually recognize the space in front of the user.

In other words, in this case, by referring to the display device 217 provided in a smartphone or a tablet terminal placed right in front of the user 20, the user 20 can visually recognize the space in front of the user 20 and behind the smartphone or the tablet terminal.

In the present exemplary embodiment, as will be described later, the user 20 is notified of various types of information via the individual device 200. Not only the glasses-type individual device 200, but also a smartphone or a tablet terminal can provide such a notification.

In the present exemplary embodiment, it can be said that a display system is composed of the display device 217 provided in the individual device 200 and the control device 211 that controls the display device 217. The control device 211 is an example of an information processing device.

### Description of Process Executed by Individual Device

In the present exemplary embodiment, the CPU 21a provided in the control device 211 controls the display on the display device 217. The CPU 21a is an example of a processor. This results in a state where an image is displayed within the field of view of the user 20.

The control of the display on the display device 217 is not limited to being performed by the CPU 21a provided in the control device 211, and may be performed by, for example, the CPU 11a provided in the management server 300 illustrated in FIG. 2.

In the present exemplary embodiment, each process is executed by any computer. The computer may execute these processes by using a processor serving as hardware, a program serving as software, or a combination thereof. In such a case, the processor is configured to perform various types of processes in the present exemplary embodiment in cooperation with the program, and may function as each unit or means in the present exemplary embodiment. The order in which the processor performs the processes is not limited to the described order, and may be changed as appropriate. The computer may be a general-purpose computer, an application specific computer, a workstation, or another system capable of performing each process.

The processor may be composed of one or more pieces of hardware, and the type of the hardware is not limited. For example, the processor may be composed of hardware such as a central processing unit (CPU 21a), a micro processing unit (MPU), a programmable logic device such as a field programmable gate array (FPGA), a dedicated circuit for performing specific processes such as an application specific integrated circuit (ASIC), a graphic processing unit (GPU), or a neural processing unit (NPU). Regarding the type of the hardware, different types of hardware may be combined. When multiple pieces of hardware are configured to perform one or more processes of a certain processor, the multiple pieces of hardware may be present in devices physically away from each other or may be present in the same device. In each exemplary embodiment, the order in which the processor performs the processes is not limited to the order described above, and may be changed as appropriate. The hardware is composed of electric circuitry in which circuit elements such as semiconductor elements are combined, or the like.

Further, the program may be firmware, or software such as microcode. For example, the program may be a program module group, and each function thereof may be realized by a processor configured to execute each function. The program may be program code or multiple code segments stored in one or more non-transitory computer readable media (for example, a storage medium or another storage). The program may be stored in a divided manner in multiple non-transitory computer readable media present in devices physically away from each other. The program code or the code segments may represent a procedure, a function, a sub program, a routine, a subroutine, a module, a software package, a class or any combination of instructions, data structures, or program statements. The program code or the code segments may be connected to another code segment or a hardware circuit by transmitting and receiving information, data, an argument, a parameter, or memory content.

For example, the individual device 200 of the present exemplary embodiment is used to support the conversation of the user 20 wearing the individual device 200. More specifically, for example, the individual device 200 is used to facilitate recognition by the user 20 of the details of remarks made by nearby persons around the user 20 when the nearby persons are having a conversation.

Hereinafter, a case will be described as an example in which two nearby persons (a first nearby person 31 and a second nearby person 32) around the user wearing the individual device 200 are having a conversation.

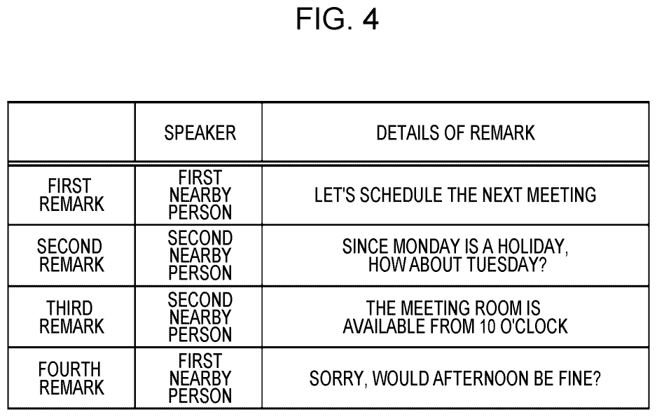

FIG. 4 is a diagram illustrating an example of the details of a conversation held between the first nearby person 31 and the second nearby person 32.

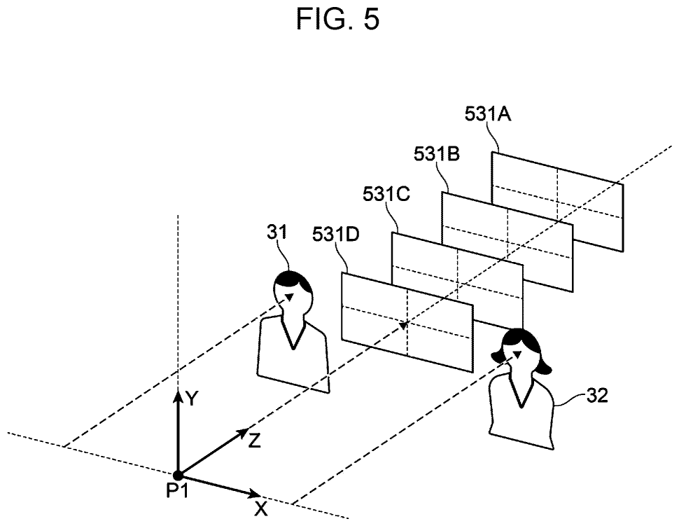

FIG. 5 is a diagram illustrating an example of an arrangement of images generated by the CPU 21a of the control device 211 in a three-dimensional space.

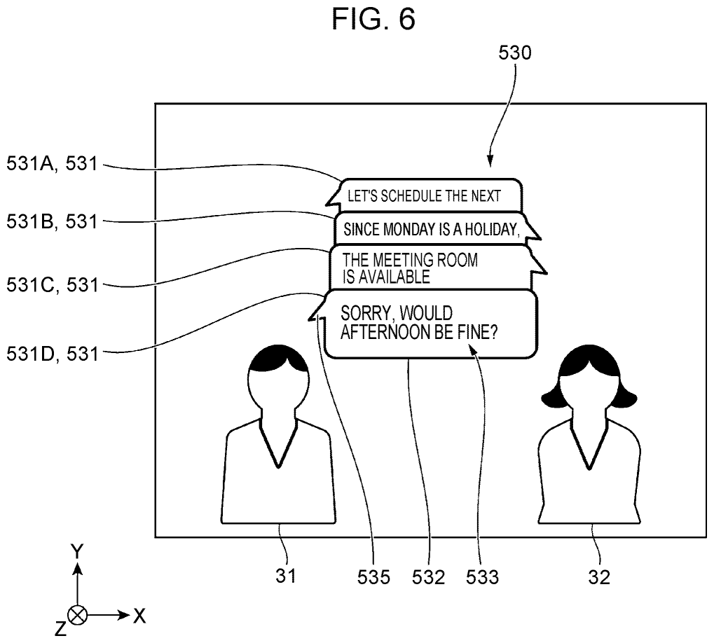

FIG. 6 is a diagram illustrating an example of a screen displayed on the display device 217. FIG. 6 corresponds to a diagram of the three-dimensional space illustrated in FIG. 5 as viewed from a point P1. In FIG. 6, the direction from left to right is referred to as the x direction, the direction from bottom to top is referred to as the y direction, and the direction from the near side to the far side of the paper is referred to as the z direction. As will be described later, the z direction is a direction in which the user 20 faces and in which the user's line of sight extends.

In the present exemplary embodiment, the device microphone 215 acquires remarks made by the first nearby person 31 and the second nearby person 32 as voices, and generates voice information. The CPU 21a acquires text information representing the details of the remarks made by the first nearby person 31 and the second nearby person 32 by analyzing the generated voice information. In other words, the CPU 21a recognizes the remarks made by the first nearby person 31 and the second nearby person 32, and converts the remarks into text information. In the present exemplary embodiment, a remark made by the first nearby person 31 or the second nearby person 32 is an example of a first voice or a second voice.

In FIG. 4, remarks made by the first nearby person 31 and the second nearby person 32 are arranged in time series from top to bottom. That is, a lower row in FIG. 4 indicates a newer remark in time series.

As illustrated in FIG. 4, the conversation between the first nearby person 31 and the second nearby person 32 includes the remark of the first nearby person 31 “Let's schedule the next meeting”, the remark of the second nearby person 32 “Since Monday is a holiday, how about Tuesday?”, the remark of the second nearby person 32 “The meeting room is available from 10 o'clock”, and the remark of the first nearby person 31 “Sorry, would afternoon be fine?”, which have been made in time series.

In the following description, the remarks of the first nearby person 31 and the second nearby person 32 may be referred to as a first remark, a second remark, a third remark, and a fourth remark in order from the oldest to the newest in time series.

In the present exemplary embodiment, the criterion for the CPU 21a to determine the time series of remarks is not particularly limited. For example, the CPU 21a may determine the time series of remarks based on the start timing of a remark made by the first nearby person 31 or the second nearby person 32. Alternatively, the CPU 21a may determine the time series of remarks based on the end timing of a remark made by the first nearby person 31 or the second nearby person 32. Alternatively, the CPU 21a may determine the time series of remarks based on the timing of an action taken by the first nearby person 31 or the second nearby person 32 during a remark.

In the present exemplary embodiment, virtual images corresponding to objects that do not exist in the real space are displayed in a three-dimensional XR (AR/VR/MR) space in an overlapping manner by using the XR (AR/VR/MR) technology. In the present exemplary embodiment, the three-dimensional XR (AR/VR/MR) space may be simply referred to as a three-dimensional space.

The CPU 21a generates display information in which virtual images are arranged in the three-dimensional space. Images based on the display information are displayed on the display device 217. That is, the CPU 21a functions as a display information generation unit that generates display information of a three-dimensional space to be displayed on the display device 217.

In the present exemplary embodiment, a case will be described as an example in which virtual images corresponding to objects that do not exist in the real space are displayed in a three-dimensional space corresponding to the real space in an overlapping manner by using the AR technology of the XR (AR/VR/MR) technology.

The CPU 21a generates display information in which a conversation image 530 is arranged in a three-dimensional space in which the first nearby person 31 and the second nearby person 32 are present. The conversation image 530 includes images obtained by converting remarks made by the first nearby person 31 and the second nearby person 32 into text information.

The conversation image 530 includes a plurality of remark images 531 corresponding to the remarks made by the first nearby person 31 and the second nearby person 32. Specifically, the conversation image 530 includes a first remark image 531A corresponding to the first remark, a second remark image 531B corresponding to the second remark, a third remark image 531C corresponding to the third remark, and a fourth remark image 531D corresponding to the fourth remark. When the first to fourth remark images 531A to 531D are not distinguished from each other, they are simply referred to as the remark image 531.

In the present exemplary embodiment, one remark image 531 of the plurality of remark images 531 is an example of a first image, and another remark image 531 that is later in time series than the one remark image 531 is an example of a second image. For example, the first remark image 531A is an example of the first image, and the second remark image 531B is an example of the second image.

The CPU 21a generates display information in which the plurality of remark images 531 is arranged respectively on different planes in the three-dimensional space. The different planes include a case where one plane is inclined with respect to the other plane and a case where one plane is parallel to the other plane.

In the present exemplary embodiment, the CPU 21a arranges the plurality of remark images 531 on planes parallel to each other in the three-dimensional space as the different planes.

When the plurality of remark images 531 is arranged on the same plane in the three-dimensional space, the number of remark images 531 that are displayable on the screen of the display device 217 may decrease.

In contrast, in the present exemplary embodiment, with the arrangement of the plurality of remark images 531 on different planes in the three-dimensional space, the number of remark images 531 that are displayable on the display device 217 can be increased compared to a case where the images are arranged on the same plane.

The CPU 21a arranges the first remark image 531A, the second remark image 531B, the third remark image 531C, and the fourth remark image 531D respectively on four planes that are arranged at predetermined intervals and parallel to each other in the three-dimensional space.

The direction in which the line of sight of the user 20 visually recognizing the three-dimensional space through the individual device 200 is oriented, is the z direction. The vertical direction in the three-dimensional space is the y direction, and the direction perpendicular to the y direction and the z direction is the x direction. In this example, the CPU 21a arranges the first remark image 531A, the second remark image 531B, the third remark image 531C, and the fourth remark image 531D respectively on four planes that are arranged at predetermined intervals in the z direction and parallel in the x direction and the y direction.

In this example, the first nearby person 31 and the second nearby person 32 are arranged in the x direction in the three-dimensional space.

The CPU 21a arranges the first remark image 531A, the second remark image 531B, the third remark image 531C, and the fourth remark image 531D in this order from the far side to the near side in the three-dimensional space.

More specifically, the CPU 21a arranges the first remark image 531A, the second remark image 531B, the third remark image 531C, and the fourth remark image 531D such that the remark image 531 that is newer in time series is located on the near side.

The near side is the side on which the user 20 can recognize the text information included in the remark image 531 when the user visually recognizes the remark image 531. In other words, the near side is the side on which the user 20 is present with respect to the remark image 531 in the three-dimensional space.

When the three-dimensional space is viewed in the z direction, the fourth remark image 531D, which is the newest in time series of the plurality of remark images 531, is displayed on the nearest side in the display device 217. This enables the user 20 to easily recognize the details of the fourth remark, which is the newest in time series, and to easily recognize the details of the conversation between the first nearby person 31 and the second nearby person 32.

Also, the CPU 21a arranges the plurality of remark images 531 on planes parallel to each other such that at least part of the regions of the plurality of remark images 531 can be visually recognized as overlapping each other when the three-dimensional space is viewed in the z direction.

With at least part of the regions of the plurality of remark images 531 being arranged to overlap each other in the three-dimensional space, the number of remark images 531 that are displayable on the display device 217 when the three-dimensional space is viewed in the z direction can be increased compared to a case where the plurality of remark images 531 does not overlap.

In this example, as illustrated in FIG. 6, the first remark image 531A, the second remark image 531B, the third remark image 531C, and the fourth remark image 531D are displayed on the display device 217 in a state visually recognizable in an overlapping manner in order from the far side to the near side.

Further, the CPU 21a arranges the plurality of remark images 531 on planes parallel to each other such that at least a part of each remark image 531 is visually recognizable as being shifted from the other remark images 531 when the three-dimensional space is viewed in the z direction.

With at least a part of each remark image 531 being arranged to be visually recognizable in the three-dimensional space, the details of the conversation between the first nearby person 31 and the second nearby person 32 are easily grasped in time series.

In this example, the plurality of remark images 531 has identical planar shapes. The plurality of remark images 531 is arranged such that the remark image 531 arranged on a far plane is shifted upward (toward the downstream side in the y direction). In this example, the positions in the x direction of the remark images 531 arranged on the respective planes are identical.

As illustrated in FIG. 6, the fourth remark image 531D, which is the newest of the plurality of remark images 531 in time series, is displayed on the display device 217 in such a state that the entirety of the image is visually recognizable. The first remark image 531A, the second remark image 531B, and the third remark image 531C, which are older than the fourth remark image 531D in time series among the plurality of remark images 531, are displayed on the display device 217 in such a state that the images are partly visually recognizable.

When the first nearby person 31 or the second nearby person 32 makes a fifth remark as the next remark after the first nearby person 31 makes the fourth remark, the CPU 21a generates a fifth remark image (not illustrated) as an image representing the details of the fifth remark. Then, the CPU 21a generates display information in which the fifth remark image is arranged on a plane parallel to the first remark image 531A to the fourth remark image 531D and located on a nearer side than the fourth remark image 531D. The fifth remark image is an example of a third image, and the fifth remark is an example of a third voice.

In this way, each time a new remark is made by the first nearby person 31 and the second nearby person 32, an image representing the details of the new remark is displayed on the display device 217 in an overlapping manner in order on the near side when the three-dimensional space is viewed in the z direction. In addition, images representing the details of past remarks move toward the far side. This enables the user 20 to grasp the details of remarks made by the first nearby person 31 and the second nearby person 32 in time series with the progress of the conversation between the first nearby person 31 and the second nearby person 32.

As described above, FIG. 6 illustrates an example of a screen displayed on the display device 217 when the user 20 views the three-dimensional space from the point P1 in FIG. 5 in the z direction. When the direction of the line of sight or the viewpoint of the user 20 viewing the three-dimensional space changes, the appearance of the remark images 531 displayed on the display device 217 changes according to the change in the direction of the line of sight or the viewpoint.

For example, this allows the user 20 to increase the region in which the user can visually recognize the first remark image 531A to the third remark image 531C displayed on the far side by changing the direction of the line of sight or the viewpoint of viewing the three-dimensional space.

Each remark image 531 includes a rectangular balloon image 532. Each remark image 531 includes a text image 533 displayed inside the balloon image 532 and composed of a character string representing the details of a remark, as an image obtained by converting a remark made by the first nearby person 31 or the second nearby person 32 into text information.

In this example, the text image 533 included in each remark image 531 is written horizontally. That is, in each remark image 531, the characters constituting the text image 533 are arranged in the x direction.

As described above, the plurality of remark images 531 is arranged such that the remark image 531 arranged on a far plane is shifted upward (toward the downstream side in the y direction).

The fourth remark image 531D, which is the newest in time series and is on the nearest side, is displayed on the display device 217 in such a state that the text image 533 is entirely visually recognizable when the three-dimensional space is viewed in the z direction. The first remark image 531A, the second remark image 531B, and the third remark image 531C, which are on the far side and are older than the fourth remark image 531D in time series, are displayed in such a state that the text images 533 are partly visually recognizable. More specifically, the first remark image 531A, the second remark image 531B, and the third remark image 531C are displayed in such a state that the first rows of the plurality of rows in the text image 533 are visually recognizable.

In the present exemplary embodiment, horizontal writing of the text image 533 included in each remark image 531 increases the number of characters in the text image 533 displayed on the display device 217 when the three-dimensional space is viewed in the z direction, compared to the case of vertical writing. This enables the user to easily grasp the details of the remark corresponding to the remark image 531 based on the characters of the text image 533 displayed on the display device 217.

In the above-described example, each remark image 531 includes the text image 533 composed of a character string representing the details of a remark, as an image obtained by converting a remark made by the first nearby person 31 or the second nearby person 32 into text information. However, the configuration of the remark image 531 is not limited thereto.

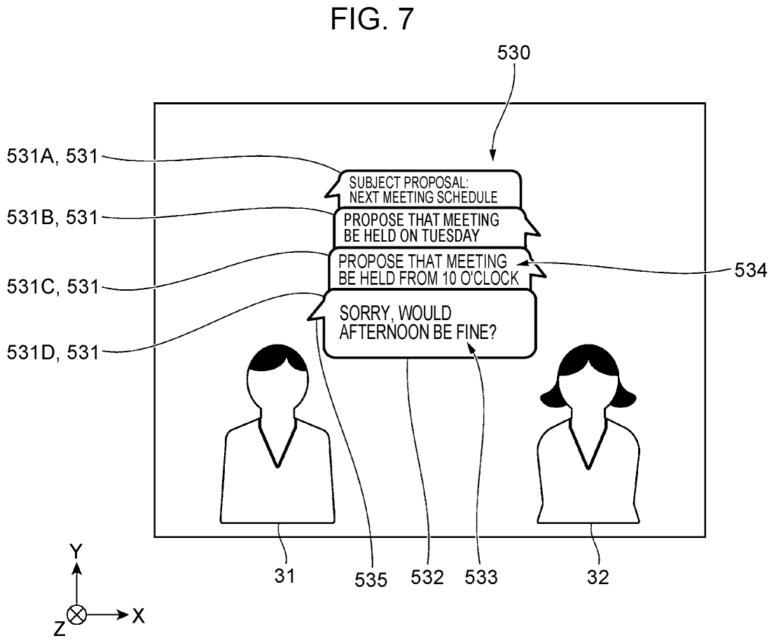

FIG. 7 is a diagram illustrating another example of a screen displayed on the display device 217. As in FIG. 6, FIG. 7 corresponds to a diagram of the three-dimensional space illustrated in FIG. 5 as viewed from the point P1.

The remark image 531 may include a summary image 534 composed of a character string representing the summary of a remark, as an image obtained by converting a remark made by the first nearby person 31 or the second nearby person 32 into text information.

In this example, the first remark image 531A to the third remark image 531C arranged on the far side of the fourth remark image 531D each include the summary image 534. This enables the user 20 to easily grasp the details of the remarks corresponding to the first remark image 531A to the third remark image 531C based on the summary image 534 even when the user cannot visually recognize the entirety of the first remark image 531A to the third remark image 531C when the user 20 views the three-dimensional space in the z direction.

On the other hand, the fourth remark image 531D, which is the newest in time series, includes the text image 533 instead of the summary image 534. This enables the user 20 to more easily and accurately grasp the details of the remark corresponding to the fourth remark image 531D based on the text image 533 when the user 20 views the three-dimensional space in the z direction.

The CPU 21a may generate the remark image 531 corresponding to a remark made by the first nearby person 31 and the remark image 531 corresponding to a remark made by the second nearby person 32 in different manners so that the user 20 can distinguish between them.

In this example, the CPU 21a changes the orientations of tails 535 of the balloon images 532 between the remark image 531 corresponding to a remark made by the first nearby person 31 and the remark image 531 corresponding to a remark made by the second nearby person 32. Specifically, with regard to the first remark image 531A and the fourth remark image 531D corresponding to remarks made by the first nearby person 31, the tails 535 of the balloon images 532 face the left side (upstream side in the x direction) where the first nearby person 31 is present. With regard to the second remark image 531B and the third remark image 531C corresponding to remarks made by the second nearby person 32, the tails 535 of the balloon images 532 face the right side (downstream side in the x direction) where the second nearby person 32 is present.

The manner in which the remark image 531 corresponding to a remark made by the first nearby person 31 and the remark image 531 corresponding to a remark made by the second nearby person 32 differ is not limited to the orientation of the tails 535 of the balloon images 532. For example, the color of the balloon image 532 or the text image 533 may be made different between the remark image 531 corresponding to a remark made by the first nearby person 31 and the remark image 531 corresponding to a remark made by the second nearby person 32. In addition, there is no particular limitation as long as the remark image 531 corresponding to a remark made by the first nearby person 31 and the remark image 531 corresponding to a remark made by the second nearby person 32 can be distinguished from each other.

While control of display on the display device 217 has been mainly described above as a process executed by the individual device 200, the present disclosure is not limited to the above-described exemplary embodiment.

In the above description, a case has been described as an example in which when two nearby persons (the first nearby person 31 and the second nearby person 32) are having a conversation, remarks made by the nearby persons are acquired as voices and converted into text information and display information is generated. The number of nearby persons whose remarks are to be converted into text information may be three or more, or may be one. More specifically, a remark of the nearby person acquired by the CPU 21a as a voice does not necessarily a conversation.

Next, another example of display information generated by the CPU 21a will be described. Same reference numerals are used for the configuration similar to that in the examples illustrated in FIGS. 5 and 6, and a detailed description will be omitted.

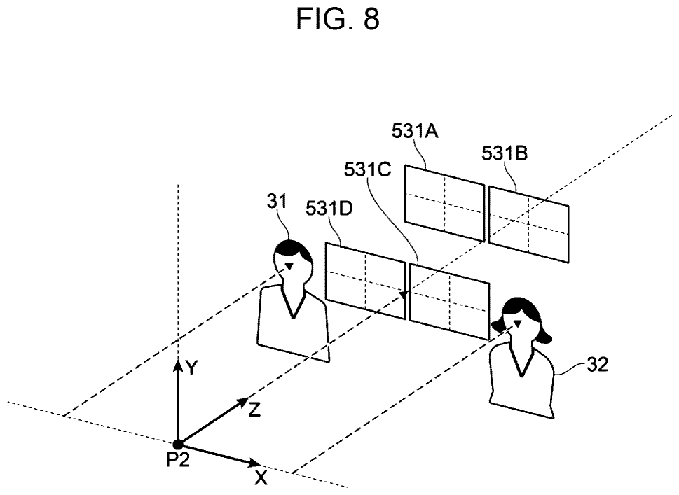

FIG. 8 is a diagram illustrating another example of an arrangement of images generated by the CPU 21a of the control device 211 in a three-dimensional space.

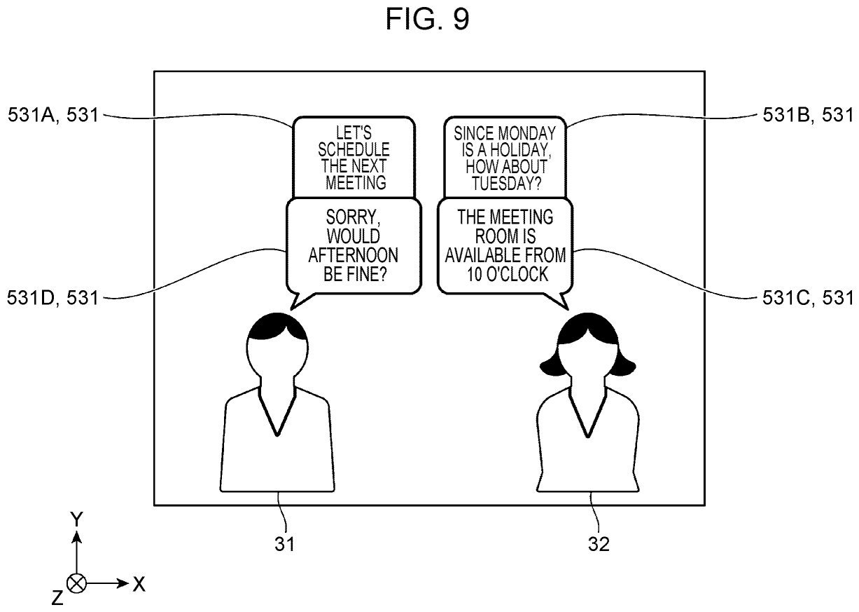

FIG. 9 is a diagram illustrating an example of a screen displayed on the display device 217. FIG. 9 corresponds to a diagram of the three-dimensional space illustrated in FIG. 8 as viewed from a point P2.

The CPU 21a may generate display information in which the plurality of remark images 531 is arranged on the same plane in the three-dimensional space when generation sources of voice are different. In the present exemplary embodiment, the first nearby person 31 and the second nearby person 32 are each an example of the generation source of voice.

The CPU 21a arranges the first remark image 531A corresponding to a remark made by the first nearby person 31 and the second remark image 531B corresponding to a remark made by the second nearby person 32, among the plurality of remark images 531, on the same plane. In this example, the CPU 21a arranges the first remark image 531A and the second remark image 531B on a plane parallel to the x direction and the y direction as the same plane.

More specifically, the CPU 21a arranges the first remark image 531A on the upstream side in the x direction on the plane parallel to the x direction and the y direction so as to correspond to the position of the first nearby person 31 in the three-dimensional space. The CPU 21a arranges the second remark image 531B on the downstream side in the x direction on the same plane as that on which the first remark image 531A is arranged, so as to correspond to the position of the second nearby person 32 in the three-dimensional space.

Similarly, the CPU 21a arranges the fourth remark image 531D corresponding to a remark made by the first nearby person 31 and the third remark image 531C corresponding to a remark made by the second nearby person 32, among the plurality of remark images 531, on the same plane. In this example, the CPU 21a arranges the third remark image 531C and the fourth remark image 531D on a plane parallel to the x direction and the y direction as the same plane. The CPU 21a arranges the third remark image 531C and the fourth remark image 531D on a plane located on the near side (upstream side in the z direction) relative to the plane on which the first remark image 531A and the second remark image 531B are arranged.

In the present exemplary embodiment, two remark images 531 with different generation sources among the plurality of remark images 531 correspond to the second and third images. In this example, the third remark image 531C corresponding to the third remark made by the second nearby person 32 is an example of the second image, and the fourth remark image 531D corresponding to the fourth remark made by the first nearby person 31 after the third remark is an example of the third image.

More specifically, the CPU 21a arranges the fourth remark image 531D on the upstream side in the x direction on the plane parallel to the x direction and the y direction so as to correspond to the position of the first nearby person 31 in the three-dimensional space. The CPU 21a arranges the third remark image 531C on the downstream side in the x direction on the same plane as that on which the fourth remark image 531D is arranged, so as to correspond to the position of the second nearby person 32 in the three-dimensional space.

In this way, in the present exemplary embodiment, with the arrangement of the plurality of remark images 531 on the same plane in the three-dimensional space when the generation sources are different, the user 20 can easily grasp that the generation sources for the remark images 531 are different.

With the arrangement of each remark image 531 on the same plane so as to correspond to the position of the first nearby person 31 or the second nearby person 32 who is the generation source, the user can easily grasp the relationship between the generation source and each remark image 531. In this example, the user 20 can easily grasp the correspondence of the plurality of remark images 531 to the remarks of the first nearby person 31 and the second nearby person 32.

In this example, the first remark image 531A and the fourth remark image 531D corresponding to remarks made by the first nearby person 31, among the plurality of remark images 531, are arranged on different planes in the three-dimensional space. The second remark image 531B and the third remark image 531C corresponding to remarks made by the second nearby person 32, among the plurality of remark images 531, are arranged on different planes in the three-dimensional space.

In other words, in this example, the remark images 531 with the same generation source are arranged on different planes in the three-dimensional space. With such an arrangement, the number of remark images 531 that are displayable on the display device 217 can be increased compared to a case where the remark images 531 with the same generation source are arranged on the same plane.

While the exemplary embodiment of the present disclosure has been described above, the technical scope of the present disclosure is not limited to the scope of the description of the exemplary embodiment described above. It is apparent from the description of claims that various modifications and improvements made to the above-described exemplary embodiment are included in the technical scope of the present disclosure.

The present disclosure is also applicable to a program and a program product.

### Appendix

(((1)))

An information processing device comprising:
a processor configured to:
function as a display information generation unit that generates display information of a three-dimensional XR (AR/VR/MR) space to be displayed on a display device possessed by a user, and
as the display information generation unit:
generate a first image obtained by converting a recognized first voice into text information;
generate a second image obtained by converting a second voice recognized after the first voice into text information; and
generate the display information in which the first image and the second image are arranged on different planes in the three-dimensional XR (AR/VR/MR) space.
(((2)))

The information processing device according to (((1))), wherein the processor is configured to generate the display information in which the first image and the second image are arranged on parallel planes in the three-dimensional XR (AR/VR/MR) space as the different planes.
(((3)))

The information processing device according to (((2))), wherein the processor is configured to generate the display information in which the first image and the second image are arranged such that at least parts of the first image and the second image overlap when the three-dimensional XR (AR/VR/MR) space is viewed in a first direction that intersects the parallel planes.
(((4)))

The information processing device according to (((3))), wherein the processor is configured to generate the display information in which the second image is arranged on a near side relative to the first image when the three-dimensional XR (AR/VR/MR) space is viewed in the first direction.
(((5)))

The information processing device according to (((4))), wherein the processor is configured to generate a third image obtained by converting a third voice recognized after the second voice into text information, and generate the display information in which the third image is arranged on a near side relative to the second image.
(((6)))

The information processing device according to (((5))), wherein the processor is configured to, when a generation source of the third voice is different from a generation source of the second voice, generate the display information in which the third image is arranged on a same plane as the second image in the three-dimensional XR (AR/VR/MR) space.
(((7)))

The information processing device according to (((6))), wherein the processor is configured to generate the display information in which the second image is arranged at a position corresponding to the generation source of the second voice and the third image is arranged at a position corresponding to the generation source of the third voice on the same plane in the three-dimensional XR (AR/VR/MR) space.
(((8)))

The information processing device according to any one of (((4))) to (((7))), wherein the processor is configured to generate the first image in which the text information is a summary of the first voice.
(((9)))

A display system comprising:
the information processing device according to any one of (((1))) to (((8))); and
the display device that displays the display information generated by the information processing device.
(((10)))

A program causing a computer to execute a process as an information processing device, the process comprising
functioning as a display information generation unit that generates display information of a three-dimensional XR (AR/VR/MR) space to be displayed on a display device possessed by a user,
the functioning as the display information generation unit including:
generating a first image obtained by converting a recognized first voice into text information;
generating a second image obtained by converting a second voice recognized after the recognized first voice into text information; and
generating the display information in which the first image and the second image are arranged on different planes in the three-dimensional XR (AR/VR/MR) space.

What is claimed is:

1. An information processing device comprising:
a processor configured to:
function as a display information generation unit that generates display information of a three-dimensional XR (AR/VR/MR) space to be displayed on a display device possessed by a user, and
as the display information generation unit:
generate a first image obtained by converting a recognized first voice into text information;
generate a second image obtained by converting a second voice recognized after the first voice into text information; and
generate the display information in which the first image and the second image are arranged on different planes in the three-dimensional XR (AR/VR/MR) space.

2. The information processing device according to claim 1, wherein the processor is configured to generate the display information in which the first image and the second image are arranged on parallel planes in the three-dimensional XR (AR/VR/MR) space as the different planes.

3. The information processing device according to claim 2, wherein the processor is configured to generate the display information in which the first image and the second image are arranged such that at least parts of the first image and the second image overlap when the three-dimensional XR (AR/VR/MR) space is viewed in a first direction that intersects the parallel planes.

4. The information processing device according to claim 3, wherein the processor is configured to generate the display information in which the second image is arranged on a near side relative to the first image when the three-dimensional XR (AR/VR/MR) space is viewed in the first direction.

5. The information processing device according to claim 4, wherein the processor is configured to generate a third image obtained by converting a third voice recognized after the second voice into text information, and generate the display information in which the third image is arranged on a near side relative to the second image.

6. The information processing device according to claim 5, wherein the processor is configured to, when a generation source of the third voice is different from a generation source of the second voice, generate the display information in which the third image is arranged on a same plane as the second image in the three-dimensional XR (AR/VR/MR) space.

7. The information processing device according to claim 6, wherein the processor is configured to generate the display information in which the second image is arranged at a position corresponding to the generation source of the second voice and the third image is arranged at a position corresponding to the generation source of the third voice on the same plane in the three-dimensional XR (AR/VR/MR) space.

8. The information processing device according to claim 4, wherein the processor is configured to generate the first image in which the text information is a summary of the first voice.

9. A display system comprising:
the information processing device according to claim 1; and
the display device that displays the display information generated by the information processing device.

10. A display system comprising:
the information processing device according to claim 2; and
the display device that displays the display information generated by the information processing device.

11. A display system comprising:
the information processing device according to claim 3; and
the display device that displays the display information generated by the information processing device.

12. A display system comprising:
the information processing device according to claim 4; and
the display device that displays the display information generated by the information processing device.

13. A display system comprising:
the information processing device according to claim 5; and
the display device that displays the display information generated by the information processing device.

14. A display system comprising:
the information processing device according to claim 6; and
the display device that displays the display information generated by the information processing device.

15. A display system comprising:
the information processing device according to claim 7; and
the display device that displays the display information generated by the information processing device.

16. A display system comprising:
the information processing device according to claim 8; and
the display device that displays the display information generated by the information processing device.

17. A non-transitory computer readable medium storing a program causing a computer to execute a process as an information processing device, the process comprising:
functioning as a display information generation unit that generates display information of a three-dimensional XR (AR/VR/MR) space to be displayed on a display device possessed by a user;
the functioning as the display information generation unit including:
generating a first image obtained by converting a recognized first voice into text information;
generating a second image obtained by converting a second voice recognized after the recognized first voice into text information; and
generating the display information in which the first image and the second image are arranged on different planes in the three-dimensional XR (AR/VR/MR) space.
